(19) United States
(12) Patent Application Publication
(10) Pub. No.: US 2014/0239740 A1
(43) Pub. Date: Aug. 28, 2014

(54) Generator Exerciser Timer with Poor Air Quality Delay

(71) Applicant: John Stellwag, Mount Laurel, NJ (US)

(72) Inventor: John Stellwag, Mount Laurel, NJ (US)

(21) Appl. No.: 14/192,115

(22) Filed: Feb. 27, 2014

Related U.S. Application Data
(60) Provisional application No. 61/851,036, filed on Feb. 28, 2013.

(51) Int. Cl. H01H 43/00

(52) U.S. Cl. CPC H01H 43/00
USPC 307/116

(57) ABSTRACT

The invention relates to an exercise timer for a generator, having a poor air quality delay function to interrupt, prevent or delay a scheduled exercise run from occurring during a period of poor air quality, as well as its methods of use.

### CROSS-REFERENCE TO RELATED APPLICATIONS

The present application is entitled to priority to U.S. Provisional Application No. 61/851,036, filed Feb. 28, 2013, which is incorporated by reference herein in its entirety.

### BACKGROUND OF THE INVENTION

In order to properly maintain a backup generator engine in good working condition, it is important to run—or exercise—the generator engine at regular intervals. Historically, this has been accomplished through the use of an exercise timer, which runs the generator engine at regular pre-determined intervals.

Fossil fuel emission, including diesel fuel, are known to contain more than 40 known and probable carcinogens, as well as fine particulate matter, commonly called soot. Every year, people die prematurely and suffer asthma attacks or other debilitating respiratory illnesses from harmful soot.

In order to improve air quality, some states have put rules and regulations in place that limit or prohibit the running of generator engines on days deemed to be poor air quality days. But when a poor air quality day will occur is unpredictable, and exercise timers that are pre-programmed to run a generator engine at a regular pre-determined interval may be programmed to run the engine during a declared poor air quality day.

Thus, there is a need in the art for temporarily interrupting, preventing or delaying the running of a diesel generator engine during a poor air quality day. The present invention fulfills this unmet need in the art.

### SUMMARY OF THE INVENTION

The invention relates to an exercise timer for a generator, having a poor air quality delay function to interrupt, prevent or delay a scheduled exercise run from occurring during a period of poor air quality, as well as its methods of use. Thus, in one embodiment, the invention is a programmable exercise timer having a poor air quality delay function comprising at least one component for inputting exercise run scheduling information into the timer, a clock, a user display, at least one component for activating the poor air quality delay, and a connection for functionally connecting the timer to a power source. In some embodiments, the at least one component for inputting exercise run scheduling information is at least one selected from the group consisting of a button, a switch, a toggle, a web-site, a phone, a mobile telephone, a radio frequency, a touch screen, text messaging, and a computing device. In various embodiments, the user display is at least one selected from the group consisting of a liquid crystal display (LCD) and a touch screen. In various embodiments, the at least one component for activating the poor air quality delay is at least one selected from the group consisting of a button, a switch, a toggle, a web-site, a phone, a mobile telephone, a radio frequency, a touch screen, text messaging, and a computing device. In some embodiments, the timer is scheduled to initiate an exercise run of one or more functionally connected generators at a pre-determined time, or at a series of pre-determined times. In some embodiments, the timer is scheduled to initiate an exercise run of one or more functionally connected generators at least once per hour, at least once per day, at least once per week, at least once per month, or at least once per year. In some embodiments, the timer is scheduled to initiate an exercise run of one or more functionally connected generators, at least twice per hour, at least twice per day, at least twice per week, at least twice per month, or at least twice per year. In some embodiments, the timer is scheduled to initiate an exercise run of one or more functionally connected generators at least thrice per hour, at least thrice per day, at least thrice per week, at least thrice per month, or at least thrice per year. In some embodiments, the timer is scheduled to terminate an initiated exercise run after at least 1 minute, at least 5 minutes, at least 10 minutes, at least 20 minutes, at least 40 minutes, at least 1 hour, at least 2 hours, at least 3 hours, at least 4 hours, at least 5 hours, at least 6 hours, at least 7 hours, at least 8 hours, at least 9 hours, at least 10 hours, at least 11 hours, at least 12 hours, at least 24 hours, at least 30 hours, at least 36 hours, at least 48 hours, or at least 3 days or more has elapsed. In some embodiments, when the at least one component for activating the poor air quality delay is activated, the poor air quality delay interrupts, prevents or delays the running of a scheduled exercise run for a period of at least 1 hour, at least 2 hours, at least 3 hours, at least 4 hours, at least 5 hours, at least 6 hours, at least 7 hours, at least 8 hours, at least 9 hours, at least 10 hours, at least 11 hours, at least 12 hours, at least 24 hours, at least 30 hours, at least 36 hours, at least 48 hours, or at least 3 days.

In one embodiment, the invention is a method of delaying a scheduled exercise run of a generator, comprising activating the poor air quality delay function of a programmable exercise timer as elsewhere described herein. In another embodiment, the invention is a method of initiating a poor air quality delay of a scheduled exercise run, comprising activating the poor air quality delay function of the programmable exercise timer as elsewhere described herein.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 depicts a pinout of one example of a 2-chip embodiment of the exercise timer.

FIG. 2 is a picture of one example of the exercise timer.

FIG. 3 is a picture of one example of the exercise timer.

FIG. 4 is a picture of one example of the exercise timer attached to a DC power source.

FIG. 5 is a picture of one example of the exercise timer.

FIG. 6 is a picture of one example of the exercise timer attached to a generator.

FIG. 7 is a picture of one example of the exercise timer on a printed circuit board.

FIG. 8 is a picture of one example of the exercise timer on a printed circuit board attached to a generator.

### DETAILED DESCRIPTION

Generally, the invention relates to an exercise timer for a generator, having a poor air quality delay function to interrupt, prevent or delay a scheduled exercise run from occurring during a period of poor air quality, as well as its methods of use.

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

### Description

It is to be understood that the figures and descriptions of the present invention have been simplified to illustrate elements that are relevant for a clear understanding of the present invention, while eliminating, for the purpose of clarity, many other elements found in typical timer systems and the methods of manufacturing and using the same. Those of ordinary skill in the art will recognize that other elements and/or steps are desirable and/or required in implementing the present invention. However, because such elements and steps are well known in the art, and because they do not facilitate a better understanding of the present invention, a discussion of such elements and steps is not provided herein. Therefore, the disclosure herein is directed to all such variations and modifications to such elements and methods as would be understood by those skilled in the art. Furthermore, the embodiments identified and illustrated herein are for exemplary purposes only, and are not meant to be exclusive or limited in their description of the present invention.

The present invention provides a unique and valuable system and method for exercising a generator at a recurring interval, while addressing the need to interrupt, prevent or delay this recurring interval during periods of poor air quality. As contemplated herein, the present invention can be used as a timer to exercise any kind of engine that may remain idle for any period of time between uses. Unlike existing systems, the present invention comprises a function for delaying a pre-scheduled exercise run to prevent the pre-scheduled exercise run from occurring during a period of poor air quality.

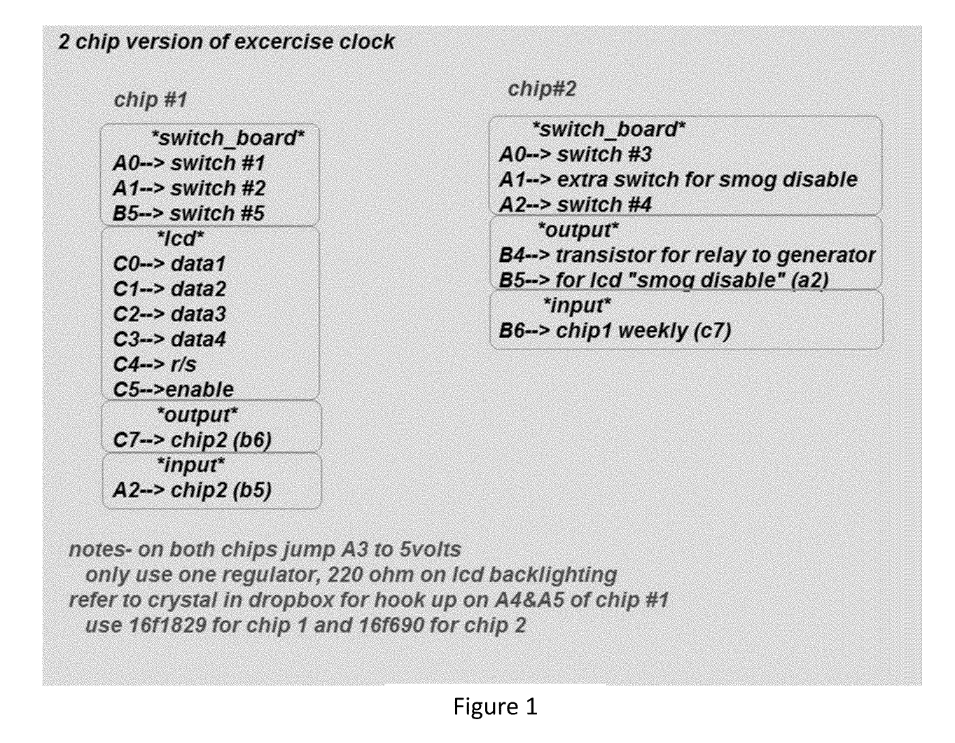

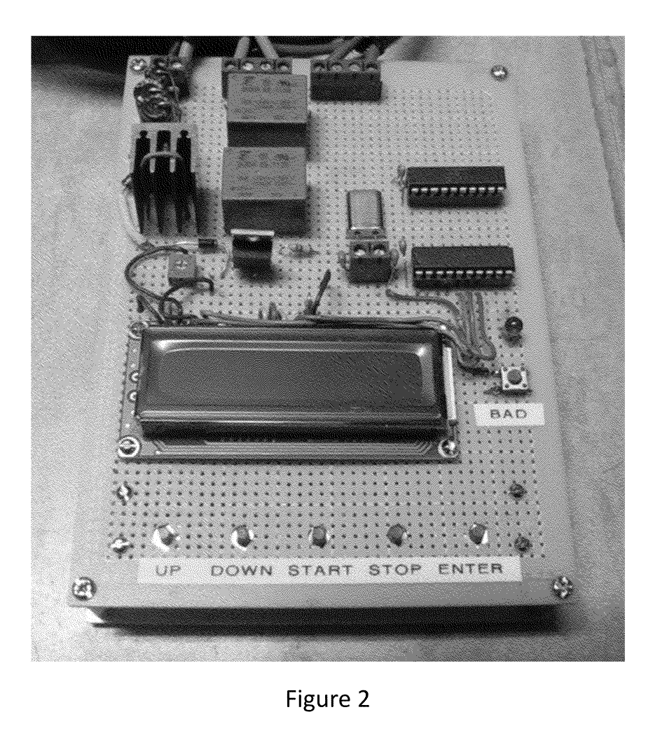

As illustrated herein, FIG. 1 depicts an exemplary pinout of an exemplary timer of the present invention. FIG. 2 represents a top view of an exemplary timer of the invention. As contemplated herein, the timer of the invention having a poor air quality delay function may be constructed as a stand-alone assembly, or can be integrated into a generator or into any component functionally integrated into generator. In some embodiments, the components of the timer may be enclosed or secured within a housing. Of course, it should be appreciated that there is no limitation as to whether a particular component of the exercise timer be on the front face, the user-operating side, or the back face, which may be hidden from view but still accessible by a user.

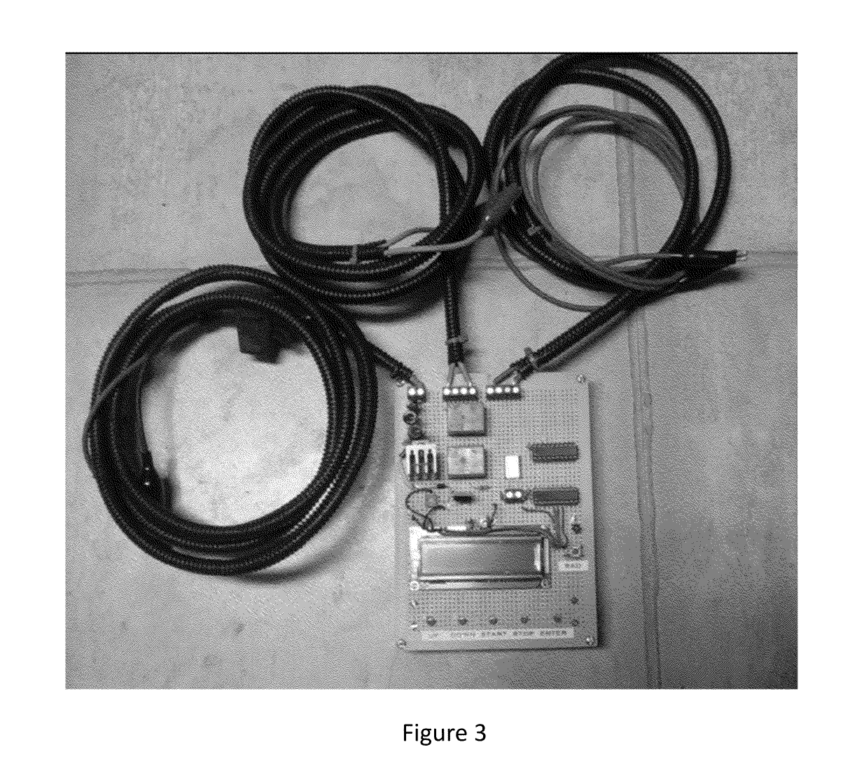

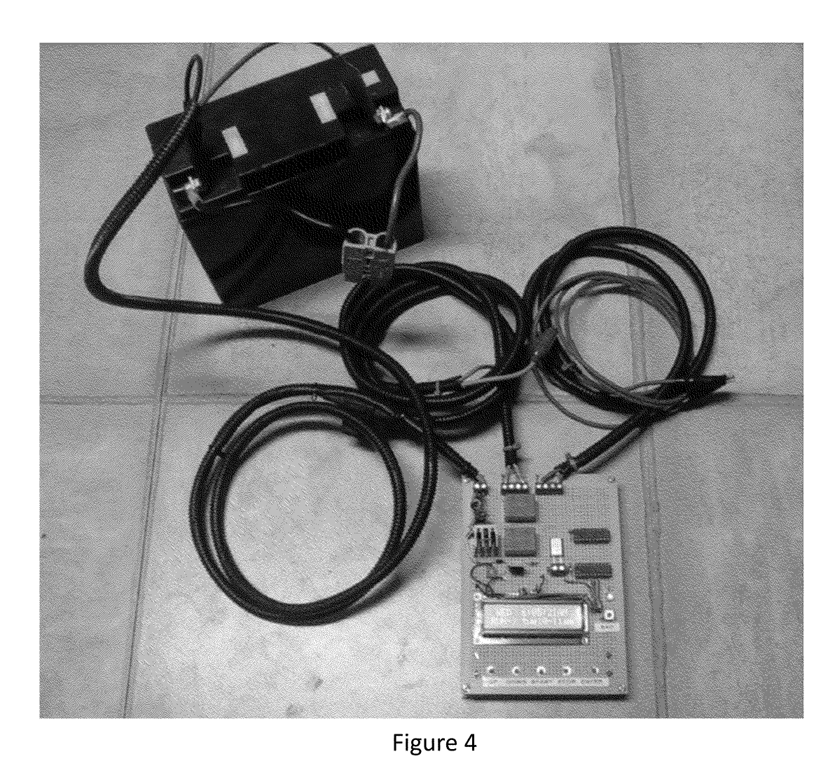

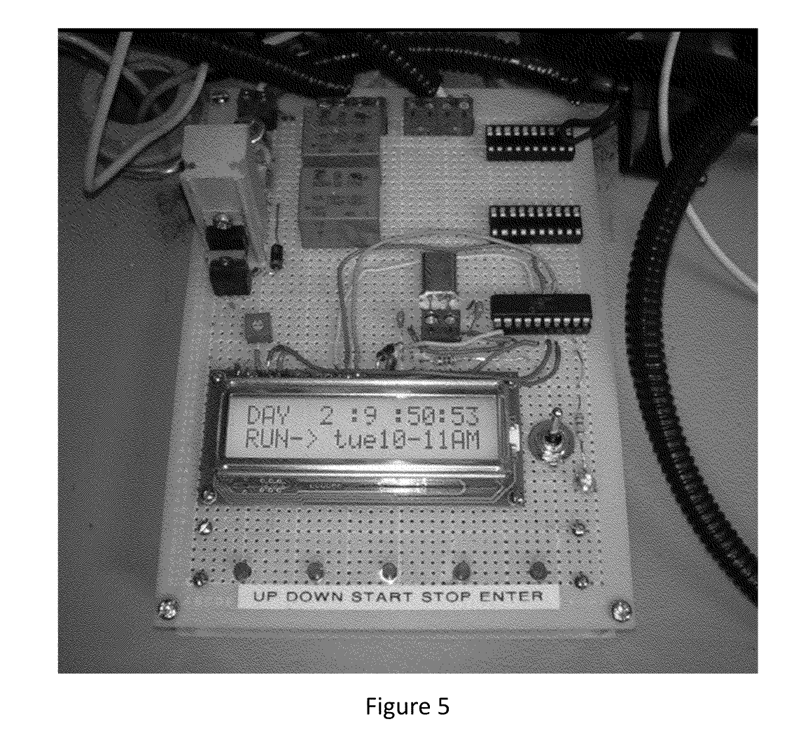

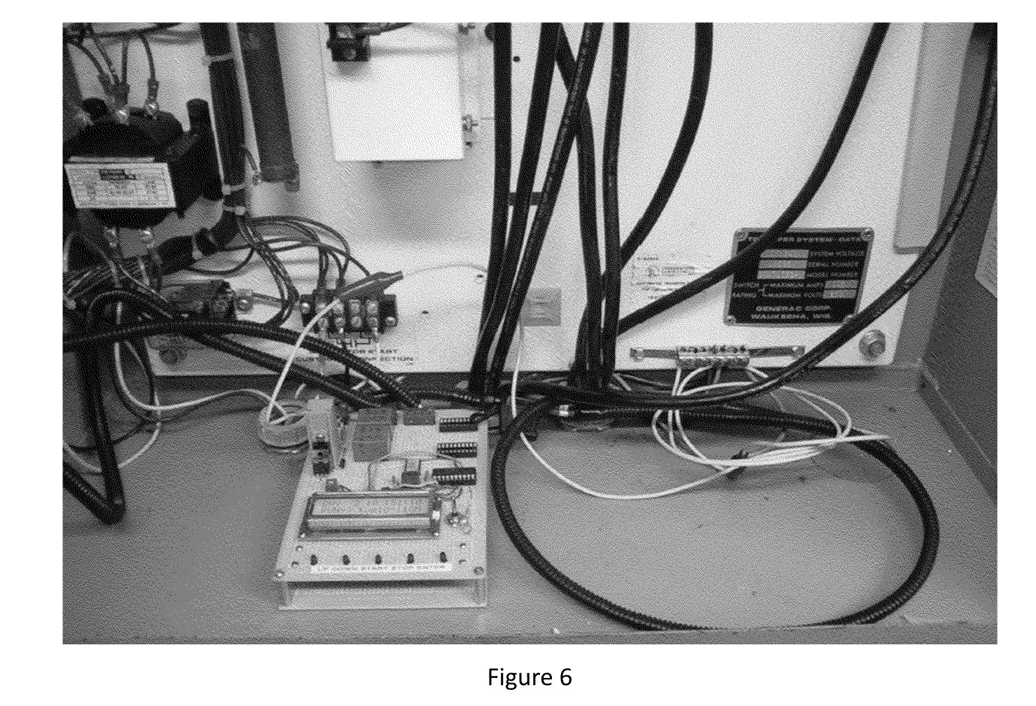

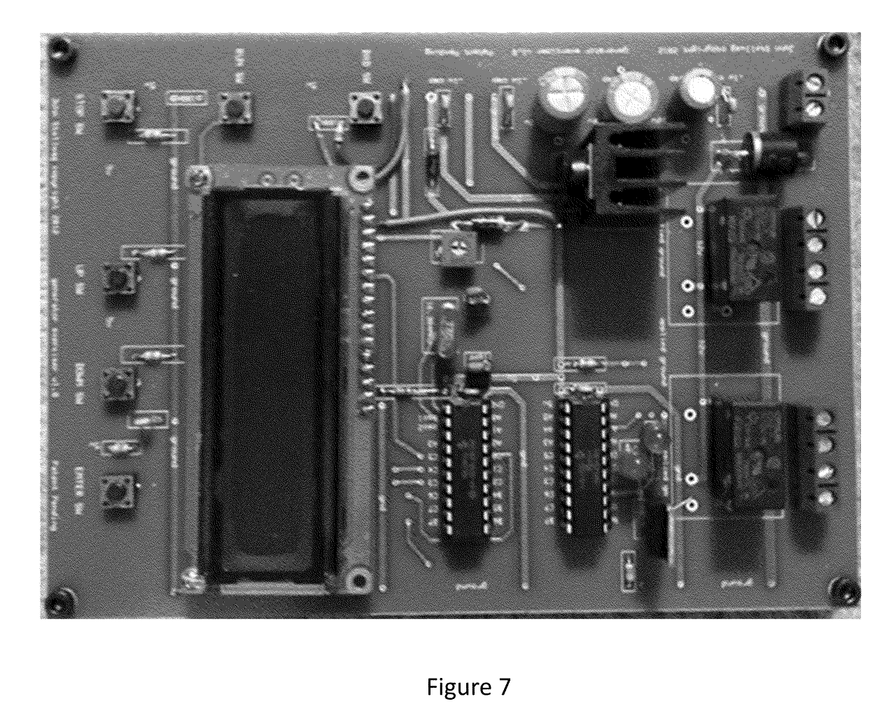

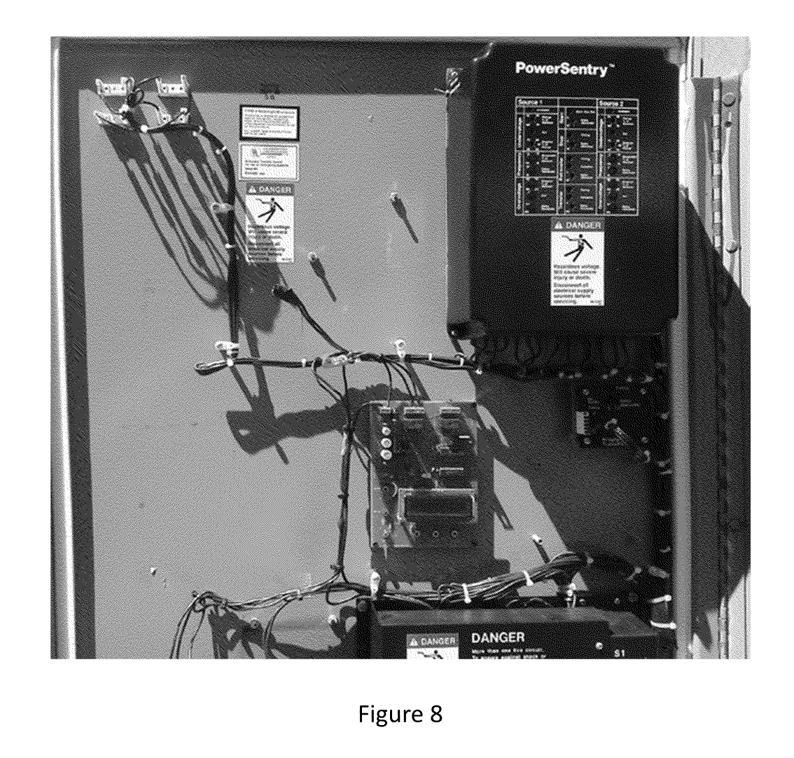

According to an aspect of the present invention and as shown generally in FIGS. 2-8, the timer includes any number of components. For example, as illustrated in FIGS. 2-8, the timer includes at least one component (e.g., buttons, switches, toggles, touch screen, etc.) for inputting scheduling information into the timer, a clock for keeping the local date and time, a user display (e.g., LCD, etc.) for displaying operating parameters, system queries and user inputs, at least one component (e.g., buttons, switches, toggles, touch screen, etc.) for activating the poor air quality delay, and a connection for functionally connecting the timer to a power source (e.g., DC and/or AC). Accordingly, the timer may include at least one computing processor, data storage, inputs and outputs, transceivers, circuitry, software drivers, a user display and any other components necessary for programming and selecting information to and from the timer either directly or via a wired or wireless communications network, as would be understood by those skilled in the art. The present invention also includes a means for the timer to interface with another electrical device. Thus, in various embodiments, the timer is electrically or mechanically connected to another electrical device, such as a generator, by standard mechanisms.

The present invention includes a means for the user to interface with the timer. In the description herein, reference to a programmable timer should be understood to be a class of timer for which a schedule is able to be programmed to regulate the operation of some characteristic, variable or operating parameter thereof, and although the Figures depict an exemplary exercise timer for exemplary purposes only, the present invention is not so limited, although an appreciation of various aspects of the invention will be gained through a discussion of the examples and embodiments described herein. It will also be understood that while the user interface of the present invention may be implemented by manually manipulating components on the timer itself, it may also be implemented via a web-site, a phone, a mobile telephone, a radio frequency, a touch screen, text messaging, a computing device application (e.g., wired, wireless, etc.), or a separate control panel device coupled to the programmable timer for which the schedule is to be created and the poor air quality day delay is to be activated.

FIGS. 2-8 include an example timer having an example manual interface, including means for inputting information into the timer, such as current date, current time, exercise run scheduling and poor air quality delay parameters. The timer can be scheduled to initiate an exercise run of one or more functionally connected generators at a pre-determined time, or at a series of pre-determined times. The timer can be scheduled to initiate an exercise run of one or more functionally connected generators at any desired time (e.g., hour/minute) of any desired day, or any desired series of times and days. By way of non-limiting examples, the timer can be scheduled to initiate an exercise run of one or more functionally connected generators, at least once per hour, at least once per day, at least once per week, at least once per month, or at least once per year. By way of other non-limiting examples, the timer can be scheduled to initiate an exercise run of one or more functionally connected generators, at least twice per hour, at least twice per day, at least twice per week, at least twice per month, or at least twice per year. By way of other non-limiting examples, the timer can be scheduled to initiate an exercise run of one or more functionally connected generators, at least thrice per hour, at least thrice per day, at least thrice per week, at least thrice per month, or at least thrice per year. The skilled artisan will understand how to select the frequency that exercise runs should programmed under the particular circumstances.

The timer can be scheduled to terminate an initiated exercise run after any desired duration of time has elapsed. By way of non-limiting examples, the timer can be scheduled to terminate an initiated exercise run after at least 1 minute, at least 5 minutes, at least 10 minutes, at least 20 minutes, at least 40 minutes, at least 1 hour, at least 2 hours, at least 3 hours, at least 4 hours, at least 5 hours, at least 6 hours, at least 7 hours, at least 8 hours, at least 9 hours, at least 10 hours, at least 11 hours, at least 12 hours, at least 24 hours, at least 30 hours, at least 36 hours, at least 48 hours, or at least 3 days or more have elapsed. The skilled artisan will understand how to select the duration of time that an exercise run should last under the particular circumstances.

The timer comprises a means for initiating the poor air quality delay function to interrupt, prevent or delay at least one pre-scheduled exercise run. The poor air quality delay function can be initiated by any direct, manual, indirect or distant means. Various non-limiting examples of means for initiating the poor air quality delay function include a button, switch, toggle, touch screen, web-site, telephone, mobile telephone, radio frequency, text messaging, a computing device application (e.g., wired, wireless, etc.), or a separate control panel device coupled to the programmable timer for which the schedule has been created and is to be interrupted by the poor air quality day delay. In one non-limiting example, the means for initiating the poor air quality day function is functionally connected to, and can by activated by, a third-party broadcast (e.g., weather authority broadcast, government authority broadcast, etc.) of the determination of the occurence a poor air quality day. The poor air quality delay can interrupt, prevent or delay the running of a scheduled exercise run for any desired duration. By way of non-limiting examples, the poor air quality delay can be scheduled to interrupt, prevent or delay the running of a scheduled exercise run for a period of at least 1 hour, at least 2 hours, at least 3 hours, at least 4 hours, at least 5 hours, at least 6 hours, at least 7 hours, at least 8 hours, at least 9 hours, at least 10 hours, at least 11 hours, at least 12 hours, at least 24 hours, at least 30 hours, at least 36 hours, at least 48 hours, or at least 3 days. The skilled artisan will understand how to select the duration of time that an exercise run should interrupted or prevented under the particular circumstances. In various embodiments, the initiated poor air quality delay can be manually reinitiated, or the initiated poor air quality delay can be programmed to automatically reinitiate until the automatic reinitiation is terminated.

It will be understood by the skilled artisan that the purpose of the poor air quality delay is to interrupt, prevent or delay the running of a pre-programmed exercise run during a period of poor air quality, for the sake of air quality. Thus, in some embodiments, the timer of the invention also includes a poor air quality delay override function to permit the generator to run for the purpose of producing power (e.g., to permit a backup generator to produce power during a power outage), even during periods of poor air quality. The poor air quality delay override function can be initiated by any direct, manual, indirect or distant means. Various non-limiting examples of means for initiating the poor air quality delay override function include a button, switch, toggle, touch screen, web-site, telephone, mobile telephone, radio frequency, text messaging, a computing device application (e.g., wired, wireless, etc.), or a separate control panel device coupled to the programmable timer. In one non-limiting example, the means for initiating the poor air quality day override function is functionally connect to, and can by activated by, a loss of power that the backup generator is tasked to replace.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A programmable exercise timer having a poor air quality delay function comprising at least one component for inputting exercise run scheduling information into the timer, a clock, a user display, at least one component for activating the poor air quality delay, and a connection for functionally connecting the timer to a power source.

2. The programmable exercise timer of claim 1, wherein the at least one component for inputting exercise run scheduling information is at least one selected from the group consisting of a button, a switch, a toggle, a web-site, a phone, a mobile telephone, a radio frequency, a touch screen, text messaging, and a computing device.

3. The programmable exercise timer of claim 1, wherein the user display is at least one selected from the group consisting of a liquid crystal display (LCD) and a touch screen.

4. The programmable exercise timer of claim 1, wherein the at least one component for activating the poor air quality delay is at least one selected from the group consisting of a button, a switch, a toggle, a web-site, a phone, a mobile telephone, a radio frequency, a touch screen, text messaging, and a computing device.

5. The programmable exercise timer of claim 1, wherein the timer is scheduled to initiate an exercise run of one or more functionally connected generators at a pre-determined time, or at a series of pre-determined times.

6. The programmable exercise timer of claim 1, wherein the timer is scheduled to initiate an exercise run of one or more functionally connected generators at least once per hour, at least once per day, at least once per week, at least once per month, or at least once per year.

7. The programmable exercise timer of claim 1, wherein the timer is scheduled to initiate an exercise run of one or more functionally connected generators, at least twice per hour, at least twice per day, at least twice per week, at least twice per month, or at least twice per year.

8. The programmable exercise timer of claim 1, wherein the timer is scheduled to initiate an exercise run of one or more functionally connected generators at least thrice per hour, at least thrice per day, at least thrice per week, at least thrice per month, or at least thrice per year.

9. The programmable exercise timer of claim 1, wherein the timer is scheduled to terminate an initiated exercise run after at least 1 minute, at least 5 minutes, at least 10 minutes, at least 20 minutes, at least 40 minutes, at least 1 hour, at least 2 hours, at least 3 hours, at least 4 hours, at least 5 hours, at least 6 hours, at least 7 hours, at least 8 hours, at least 9 hours, at least 10 hours, at least 11 hours, at least 12 hours, at least 24 hours, at least 30 hours, at least 36 hours, at least 48 hours, or at least 3 days or more has elapsed.

10. The programmable exercise timer of claim 1, wherein when the at least one component for activating the poor air quality delay is activated, the poor air quality delay interrupts, prevents or delays the running of a scheduled exercise run for at least 1 hour, at least 2 hours, at least 3 hours, at least 4 hours, at least 5 hours, at least 6 hours, at least 7 hours, at least 8 hours, at least 9 hours, at least 10 hours, at least 11 hours, at least 12 hours, at least 24 hours, at least 30 hours, at least 36 hours, at least 48 hours, or at least 3 days.

11. A method of delaying a scheduled exercise run of a generator, comprising activating the poor air quality delay function of the programmable exercise timer of claim 1.

12. A method of initiating a poor air quality delay of a scheduled exercise run, comprising activating the poor air quality delay function of the programmable exercise timer of claim 1.
